(19) United States
(12) Patent Application Publication
(10) Pub. No.: US 2024/0075703 A1
(43) Pub. Date: Mar. 7, 2024

(54) WIND-RESISTANT FANFOLD SUPPLY SUPPORT

(71) Applicant: Pregis Innovative Packaging LLC, Chicago, IL (US)

(72) Inventors: Thomas D. Wetsch, Naples, FL (US); Eric Charles Wright, Bollingbrook, IL (US)

(21) Appl. No.: 18/325,768

(22) Filed: May 30, 2023

Related U.S. Application Data
(63) Continuation of application No. 15/593,078, filed on May 11, 2017, now abandoned.

(51) Int. Cl. B31D 5/00; B65H 16/00; B65H 20/00; B65H 35/00

(52) U.S. Cl. CPC B31D 5/0052; B31D 5/0039; B65H 16/005; B65H 20/005; B65H 35/008; B31D 2205/0035; B31D 2205/0047; B31D 2205/0058; B31D 2205/0082; B65H 2801/63

(57) ABSTRACT

Disclosed herein are protective packaging stock material units that are used in a dunnage system. A dunnage system includes a dunnage conversion machine and a supply station. The supply station is configured to receive fanfold stock material and manipulate the fanfold stock material into being withdrawn from the supply station in a non-planar configuration. The supply station is associated with the dunnage conversion machine such that the dunnage conversion machine operably draws fanfold stock material from the top of a stack of fanfold stock material.

### CROSS-REFERENCE TO RELATED APPLICATIONS

The present application is a continuation of U.S. patent application Ser. No. 15/593,078, filed May 11, 2017, which is incorporated herein by reference in its entirety.

### TECHNICAL FIELD

This invention is in the field of protective packaging systems and materials, particularly supports and configurations for the fanfold material used in the protective packaging systems.

### BACKGROUND

In the context of paper-based protective packaging, paper sheet is crumpled to produce dunnage. Most commonly, this type of dunnage is created by running a generally continuous strip of paper into a dunnage conversion machine that converts a compact supply of stock material, such as a roll of paper or a fanfold stack of paper, into a lower density dunnage material. The supply of stock material, such as in the case of fanfold paper, is pulled into the conversion machine from a stack that is either continuously formed or formed with discrete section connected together. The continuous strip of crumpled sheet material may be cut into desired lengths to effectively fill void space within a container holding a product. The dunnage material may be produced on an as-needed basis for a packer.

The forming of dunnage material occurs in a variety of locations. These locations are subject to a variety of conditions including wind. As such the supply and anti-runout of stock material is regularly subject to windy conditions, whether natural or from a fan. Wind presents a distinct problem for the feeding of stock material, namely, the material gets caught by the wind sometimes causing the material to run out away from the conversion machine. While barriers can be put in place to either block the wind or catch the stock material as it is blow, the barriers increase the cost, weight, and clutter in and around dunnage conversion systems.

### SUMMARY OF THE INVENTION

Embodiments include a dunnage machine supply station. The dunnage machine supply station includes a support that holds a stack of fanfolded stock material such that stock material is able to be withdrawn from the top of the stack by a dunnage conversion machine that converts the stock material into low-density dunnage. The support includes a fanfold bending member that causes fanfolds in the fanfolded stock material to bend to resist unfolding upon pulling the material from the top of the stack in a direction across the fanfolds and non-perpendicularly to the top surface of the stack, thereby resisting run-out from air currents blowing on an unfolded portion of the stock material that has been pulled off of the stack.

The supply station may include an anti-runout apparatus that manipulates the shape of the fanfold stock material. The anti-runout apparatus may support and manipulate the fanfold stock material into the non-planar configuration. The anti-runout apparatus manipulates the fanfold stock material into a shape that is convex in the downstream direction. The anti-runout apparatus may manipulate the fanfold stock material into a shape that is concave in the downstream direction. The anti-runout apparatus may include an arched surface that supports the bottom of the stack of fanfold stock material. The arched surface may be an arched piece of sheet material configured to support the fanfold stock material. The arched surface may include an arch that has a height of greater than 5% of the width of the fanfold stock material and less than 50% the width of the fanfold stock material.

Alternatively or additionally, the anti-runout apparatus include side walls that are separated by a distance that is narrower than the width of the fanfold stock material.

Alternatively or additionally, the anti-runout apparatus comprises a single stud. The stud may be positioned to support the stack of fanfold stock material at about the middle of the stack of fanfold stock material. The stud may be perpendicular to a transverse width of the stack such that the transverse ends of the stack are unsupported by the stud causing the stack to conform to a non-planar shape.

The anti-runout apparatus may include support structures at the transverse ends of the stack of fanfold stock material such that the middle of the stack of fanfold stock material is unsupported, causing the stack of fanfold stock material to conform to a non-planar shape by sagging along a middle portion of the stack of fanfold stock material. The supply station may support a plurality of separate stacks of fanfold stock material with one or more of the separate stacks of fanfold stock material having a non-planar configuration.

The plurality of stacks of fanfold stock material may be daisy chained together. An arched surface may form the base surface of the supply station with the plurality of separate stacks of fanfold stock material stacked above the arched surface. The anti-runout apparatus may additionally applies resistance to the fanfold stock material as the fanfold stock material is removed from the stack of fanfold stock material. The anti-runout apparatus may include a resistance mechanism located on transverse end walls of the supply station and the resistance mechanism is configured to apply a drag to the fanfold stock material as it is removed from the top of the stack of fanfold stock material. Alternatively or additionally, the anti-runout apparatus may include a resistance mechanism located proximal to the middle portion of the supply station so that the resistance mechanism is configured to apply a drag to the middle portion of the stock material as it is removed from the top of the stack of fanfold stock material.

The stock material may have a fan folded portion at and proximal to the stack and an unfolded portion extending away from the folded portion of the stock material, the supply station configured to hold the stack of fanfold stock material such that the stack of fanfold stock material assumes a non-planar configuration that resists run-out from air currents blowing on the unfolded portion of the stock material that has been pulled off of the stack of fanfold stock material as the stock material is unfolded due to withdrawal from the supply station.

In accordance with various embodiments, a dunnage system may include the dunnage machine supply station discussed above. The system may include stock material loaded into the supply station. The system may also include a dunnage conversion machine that withdraws the stock material from the dunnage machine supply station and converts the stock sheet material into low-density dunnage.

In accordance with various embodiments, a dunnage system may include a dunnage conversion machine; and a supply station having an anti-runout apparatus. The supply station may be configured to receive a fanfold stock material and the anti-runout apparatus being configured to manipulate the fanfold stock material by applying a drag to the fanfold stock material as it is withdrawn from the top of a stack of fanfold stock material. The supply station may be associated with the dunnage conversion machine such that the dunnage conversion machine operably draws fanfold stock material from the top of the stack of fanfold stock material.

### BRIEF DESCRIPTION OF DRAWINGS

The drawing figures depict one or more implementations in accordance with the present concepts, by way of example only, not by way of limitations. In the figures, like reference numerals refer to the same or similar elements.

FIG. 1A is a perspective view of an embodiment of a dunnage conversion system;

FIG. 1B is a rear view of the embodiment of FIG. 1A of the dunnage conversion system;

FIG. 1C is a side view of the embodiment of FIG. 1A of the dunnage conversion system;

FIG. 2 is a perspective view of part of the embodiment of the dunnage conversion machine of FIG. 1A;

FIG. 3A is a perspective view of an embodiment of a supply station holding stock material;

FIG. 3B is a rear view of an embodiment of a supply station holding stock material;

FIG. 3C is a rear view of an embodiment of a supply station holding stock material;

FIG. 3D is a rear view of an embodiment of a supply station holding stock material;

FIG. 4A is a perspective view of an embodiment of a supply station holding stock material;

FIG. 4B is a perspective view of an embodiment of a supply station holding stock material;

FIG. 4C is a perspective view of an embodiment of a supply station holding stock material;

FIG. 4D is a perspective view of an embodiment of a supply station holding stock material;

FIG. 5A is a detail view of the embodiment of the supply station having a resistance mechanism taken along detail II-II from the supply station illustrated in FIG. 4A;

FIG. 5B is a perspective view of an embodiment of a supply station having another embodiment of a resistance mechanism;

FIG. 6A is a perspective view of an embodiment of a conversion apparatus and supply cart holding stock material;

FIG. 6B is a bottom perspective view of the embodiment of supply cart holding stock material of FIG. 6A;

FIG. 6C is a bottom detail view of the embodiment of the supply cart holding stock material of FIG. 6B taken along detail I-I;

FIG. 7A is a perspective view of another embodiment of a conversion apparatus and supply cart holding stock material;

FIG. 7B is a rear view of the embodiment of supply cart holding stock material of FIG. 7A;

FIG. 7C is a top view of the embodiment of the supply station of FIGS. 7A and 7B;

FIG. 8A is a rear isometric view of a fanfold stack on a curved support with material being withdrawn vertically from the top thereof; and

FIG. 8B is a rear isometric view of a fanfold stack on a curved support with material being withdrawn vertically from the top thereof and with air flow blowing laterally across the fanfold stack.

### DETAILED DESCRIPTION

A system and apparatus for converting a stock material into dunnage is disclosed. The present disclosure is generally applicable to systems and apparatus where supply material, such as a stock material, is processed. The stock material is processed by longitudinal crumple machines that form creases longitudinally in the stock material to form dunnage or by cross crimple machines that forms creases transversely across the stock material. The stock material may be stored in a roll (whether drawn from inside or outside the roll), a wind, a fan-folded source, or any other suitable form. The stock material may be continuous or perforated. The conversion apparatus is operable to drive the stock material in a first direction, which can be an anti-runout direction. The conversion apparatus is fed the stock material from the repository through a drum in an anti-runout direction. The stock material can be any suitable type of protective packaging material including for example other dunnage and void fill materials, inflatable packaging pillows, etc. Some embodiments use supplies of other paper or fiber-based materials in sheet form, and some embodiments use supplies of wound fiber material such as ropes or thread, and thermoplastic materials such as a web of plastic material usable to form pillow packaging material. Examples of paper used include fan folded stock sheets with 30 inch transverse widths and/or 15 inch transverse widths. Preferably these sheets are fan folded as single layers. In other embodiments, the multiple layers of sheets can be fan folded together such that dunnage is made of superimposed sheets that get crumpled together.

The conversion apparatus is used with a cutting mechanism operable to sever the dunnage material. More particularly, the conversion apparatus including a mechanism for cutting or assisting the cutting of the dunnage material at desired lengths is disclosed. In some embodiments, the cutting mechanism is used with no or limited user interaction. For example, the cutting mechanism punctures, cuts, or severs the dunnage material without the user touching the dunnage material or with only minor contact of the dunnage material by the user. Specifically, a biasing member is used to bias the dunnage material against or around a cutting member to improve the ability of the system to sever the dunnage material. The biased position of the dunnage material is used in connection with or separately from other cutting features such as reversing the direction of travel of the dunnage material.

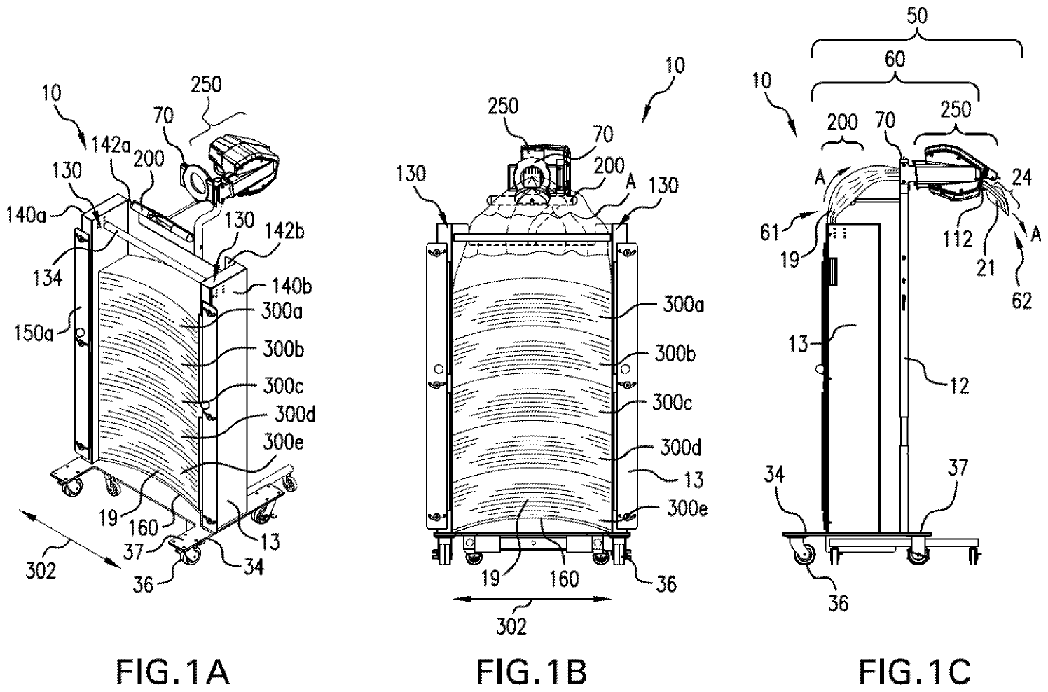

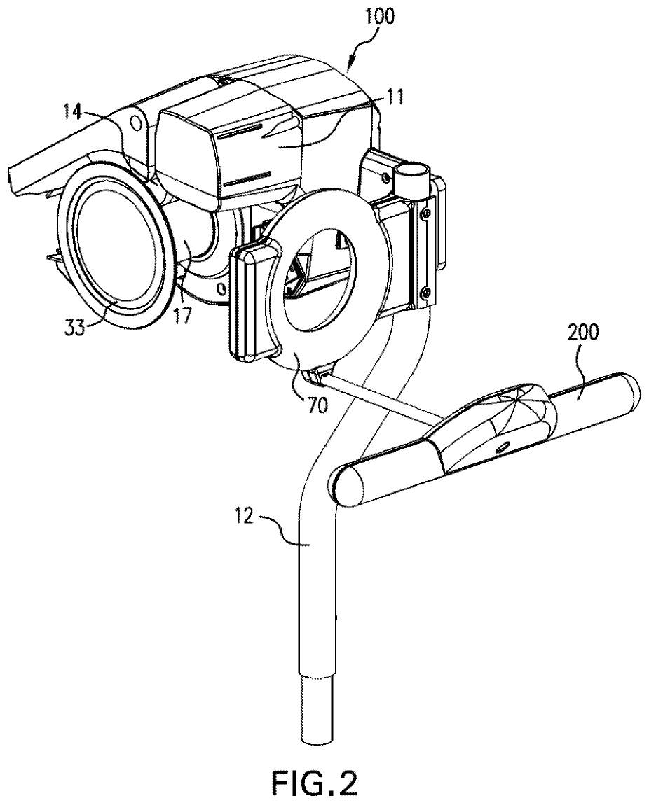

With reference to FIGS. 1A, 1B, 1C, and 2 a dunnage conversion system 10 is disclosed. The dunnage conversion system 10 may include one or more of a supply of stock material 19 and a dunnage apparatus 50. The dunnage apparatus 50 may include one or more of a supply station 13 and a dunnage conversion machine 100. The dunnage conversion machine 100 may include one or more of a converting station 60, a drive mechanism 250, and a support 12. Generally the dunnage conversion system is operable for processing the stock material 19. In accordance with various embodiments, the converting station 60 includes an intake 70 that receives the stock material 19 from a supply station 13. The drive mechanism 250 is able to pull or assist in pulling the stock material 19 into the intake 70. In some embodiments, the stock material 19 engages an intake bar 200 prior to the intake 70. The intake bar 200 may include a shaping member 210 suitable to cause the stock material 19 to begin curving before entering the intake 70. The drive mechanism 250, in conjunction with edge 112, assists a user in cutting or severing dunnage material 21 at a desired point. The dunnage material 21 is converted from stock material 19, which is itself delivered from a bulk material supply 61 and delivered to the conversion station for converting to dunnage material 21 and then through the drive mechanism 250 and the cutting edge 112.

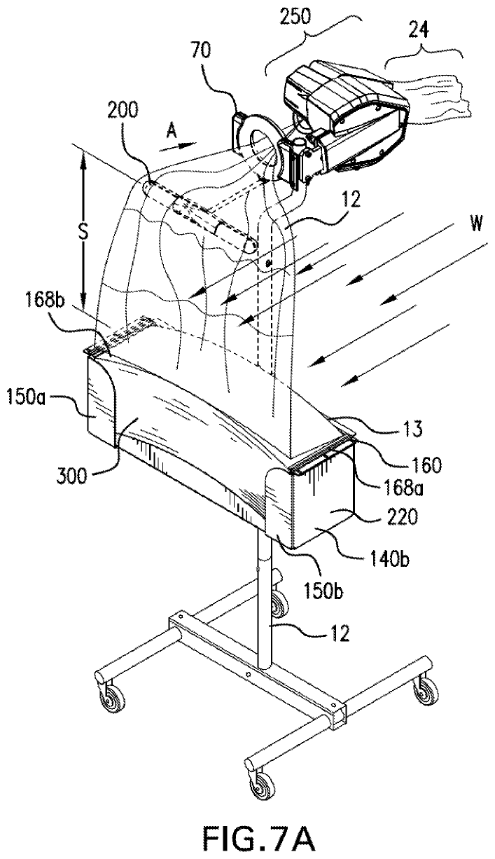

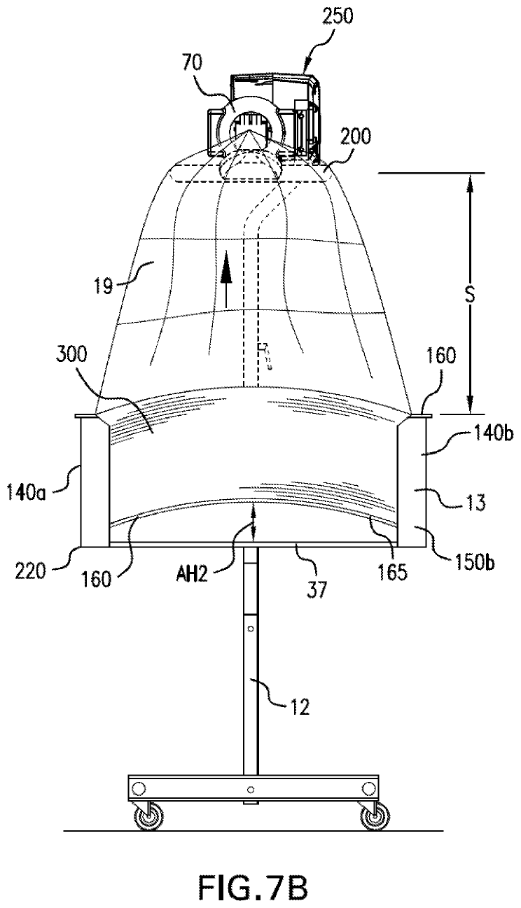

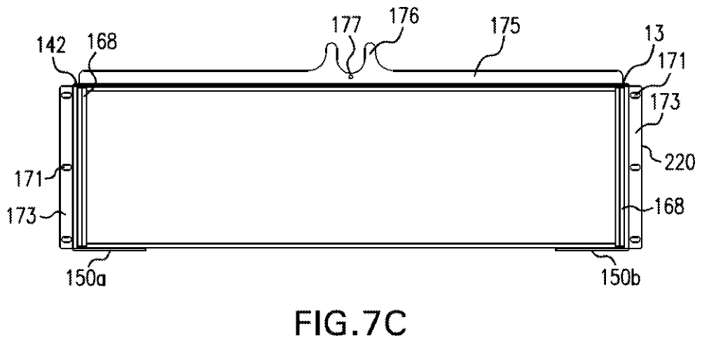

In accordance with various examples, as shown in FIGS. 1A and 1B, the stock material 19 is allocated from a bulk supply shown as multiple units of stock material 300a-e, but can also be a singular unit 300 as shown in FIG. 7A. The stock material 19 can be stored as stacked bales of fan-fold material. However, as indicated above, any other suitable type of supply or stock material may be used. The stock material 19 can be contained in the supply station 13. In one example, the supply station 13 is a cart 34 movable relative to the dunnage conversion system 10. The cart 34 includes side walls 140a, 140b. The side walls can define 140a, 140b a magazine 130 suitable to contain multiple units of stock material 300 that the stock material 19 can be pulled from. In other examples, the supply station 13 is not moveable relative to the dunnage conversion system 10. For example, the supply station 13 may be a single magazine, basket, or other container mounted to or near the dunnage conversion system 10.

The stock material 19 is fed from the supply side 61 through the intake 70. The stock material 19 begins being converted from dense stock material 19 to less dense dunnage material 21 by the intake 70 and then pulled through the drive mechanism 250 and dispensed in an anti-runout direction A on the out-feed side 62 of the intake 70. The material can be further converted by the drive mechanism 250 by allowing rollers or similar internal members to crumple, fold, flatten, or perform other similar methods that further tighten the folds, creases, crumples, or other three dimension structure created by intake 70 into a more permanent shape creating the low-density configuration of dunnage material. The stock material 19 can include continuous (e.g. continuously connected stacks, rolls, or sheets of stock material), semi-continuous (e.g. separated stacks or rolls of stock material), or non-continuous (e.g. single discrete or short lengths of stock material) stock material 19 allowing for continuous, semi-continuous or non continuous feeds into the dunnage conversion system 10. Multiple lengths can be daisy-chained together. Further, it is appreciated that various structures of the intake 70 on longitudinal crumpling machines can be used, such as those intakes forming a part of the converting stations disclosed in U.S. Pat. Pub. No. 2013/0092716, U.S. Publication 2012/0165172, U.S. Publication No 2011/0052875, and U.S. Pat. No. 8,016,735. Examples of cross crumpling machines include U.S. Pat. No. 8,900,111.

In one configuration, the dunnage conversion system 10 can include a support portion 12 for supporting the station. In one example, the support portion 12 includes an inlet guide 70 for guiding the sheet material into the dunnage conversion system 10. The support portion 12 and the inlet guide 70 are shown with the inlet guide 70 extending from the post. In other embodiments, the inlet guide may be combined into a single rolled or bent elongated element forming a part of the support pole or post. The elongated element extends from a floor base configured to provide lateral stability to the converting station. In one configuration, the inlet guide 70 is a tubular member that also functions as a support member for supporting, crumpling and guiding the stock material 19 toward the drive mechanism 250. Other inlet guide designs such as spindles may be used as well.

In accordance with various embodiments, the advancement mechanism is an electromechanical drive such as an electric motor 11 or similar motive device. The motor 11 is connected to a power source, such as an outlet via a power cord, and is arranged and configured for driving the dunnage conversion system 10. The motor 11 is an electric motor in which the operation is controlled by a user of the system, for example, by a foot pedal, a switch, a button, or the like. In various embodiments, the motor 11 is part of a drive portion, and the drive portion includes a transmission for transferring power from the motor 11. Alternatively, a direct drive can be used. The motor 11 is arranged in a housing and is secured to a first side of the central housing, and a transmission is contained within the central housing and operably connected to a drive shaft of the motor 11 and a drive portion, thereby transferring motor 11 power. Other suitable powering arrangements can be used.

The motor 11 is mechanically connected either directly or via a transmission to a drum 17, shown in FIG. 2, which causes the drum 17 to rotate with the motor 11. During operation, the motor 11 drives the drum 17 in either an anti-runout direction or a reverse direction (i.e., opposite of the anti-runout direction), which causes drum 17 to dispense the dunnage material 21 by driving it in the anti-runout direction, depicted as arrows “A” in FIGS. 1C and 2, or withdraw the dunnage material 21 back into the conversion machine in the direction opposite of A. The stock material 19 is fed from the supply side 61 of the intake 70 and over the drum 17, forming the dunnage material 21 that is driven in the anti-runout direction “A” when the motor 11 is in operation. While described herein as a drum, this element of the driving mechanism may also be wheels, conveyors, belts or any other suitable device operable to advance stock material or dunnage material through the system.

In accordance with various embodiments, the dunnage conversion system 10 includes a pinch portion operable to press on the material as it passes through the drive mechanism 250. As an example, the pinch portion includes a pinch member such as a wheel, roller, sled, belt, multiple elements, or other similar member. In one example, the pinch portion includes a pinch wheel 14. The pinch wheel 14 is supported via a bearing or other low friction device positioned on an axis shaft arranged along the axis of the pinch wheel 14. In some embodiments, the pinch wheel can be powered and driven. The pinch wheel 14 is positioned adjacent to the drum such that the material passes between the pinch wheel 14 and the drum 17. In various examples, the pinch wheel 14 has a circumferential pressing surface arranged adjacent to or in tangential contact with the surface of the drum 17. The pinch wheel 14 may have any suitable size, shape, or configuration. Examples of size, shape, and configuration of the pinch wheel may include those described in U.S. Pat. Pub. No. 2013/0092716 for the press wheels. In the examples shown, the pinch wheel 14 is engaged in a position biased against the drum 17 for engaging and crushing the stock material 19 passing between the pinch wheel 14 and the drum 17 to convert the stock material 19 into dunnage material 21. The drum 17 or the pinch wheel 14 is connected to the motor 11 via a transmission (e.g., a belt drive or the like). The motor 11 causes the drum or the pinch wheel to rotate.

In accordance with various embodiments, the drive mechanism 250 may include a guide operable to direct the material as it is passes through the pinch portion. In one example, the guide may be a flange 33 mounted to the drum 17. The flange 33 may have a diameter larger than the drum 17 such that the material is kept on the drum 17 as it passes through the pinch portion.

The drive mechanism 250 controls the incoming dunnage material 19 in any suitable manner to advance it from a conversion device to the cutting member. For example, the pinch wheel 14 is configured to control the incoming stock material. When the high-speed incoming stock material diverges from the longitudinal direction, portions of the stock material contacts an exposed surface of the pinch wheels, which pulls the diverging portion down onto the drum and help crush and crease the resulting bunching material. The dunnage may be formed in accordance with any suitable techniques including ones referenced to herein or ones known such as those disclosed in U.S. Pat. Pub. No. 2013/0092716.

In accordance with various embodiments, the conversion apparatus 10 can be operable to change the direction of the stock material 19 as it moves within the conversion apparatus 10. For example, the stock material is moved by a combination of the motor 11 and drum 17 in a forward direction (i.e., from the inlet side to the anti-runout side) or a reverse direction (i.e., from the anti-runout side to the supply side 61 or direction opposite the anti-runout direction). This ability to change direction allows the drive mechanism 250 to cut the dunnage material more easily by pulling the dunnage material 19 directly against an edge 112. As, the stock material 19 is fed through the system and dunnage material 21 it passes over or near a cutting edge 112 without being cut.

Preferably, the cutting edge 112 can be curved or directed downward so as to provide a guide that deflects the material in the out-feed segment of the path as it exits the system near the cutting edge 112 and potentially around the edge 112. The cutting member 110 can be curved at an angle similar to the curve of the drum 17, but other curvature angles could be used. It should be noted that the cutting member 110 is not limited to cutting the material using a sharp blade, but it can include a member that causes breaking, tearing, slicing, or other methods of severing the dunnage material 21. The cutting member 110 can also be configured to fully or partially sever the dunnage material 21.

In various embodiments, the transverse width of the cutting edge 112 is preferably about at most the width of the drum 17. In other embodiments, the cutting edge 112 can have a width that is less than the width of the drum 17 or greater than the width of the drum 17. In one embodiment, the cutting edge 112 is fixed; however, it is appreciated that in other embodiments, the cutting edge 112 could be moveable or pivotable. The edge 112 is oriented away from the driving portion. The edge 112 is preferably configured sufficient to engage the dunnage material 21 when the dunnage material 21 is drawn in reverse. The edge 112 can comprise a sharp or blunted edge having a toothed or smooth configuration, and in other embodiments, the edge 112 can have a serrated edge with many teeth, an edge with shallow teeth, or other useful configuration. A plurality of teeth are defined by having points separated by troughs positioned there between.

Generally, the dunnage material 21 follows a material path A as shown in FIG. 1C. As discussed above, the material path A has a direction in which the material 19 is moved through the system. The material path A has various segments such as the feed segment from the supply side 61 and severable segment 24. The dunnage material 21 on the out-feed side 62 substantially follows the path A until it reaches the edge 112. The edge 112 provides a cutting location at which the dunnage material 21 is severed. The material path can be bent over the edge 112.

As discussed above, any suitable stock material may be used. For example, the stock material may have a basis weight of about at least 20 lbs., to about, at most, 100 lbs. Examples of paper used include 30 pound kraft paper. The stock material 19 comprises paper stock stored in a high-density configuration having a first longitudinal end and a second longitudinal end that is later converted into a low-density configuration. The stock material 19 is a ribbon of sheet material that is stored in a fan-fold structure, as shown in FIG. 1A, or in coreless rolls. The stock material is formed or stored as single-ply or multiple plies of material. Where multi-ply material is used, a layer can include multiple plies. It is also appreciated that other types of material can be used, such as pulp-based virgin and recycled papers, newsprint, cellulose and starch compositions, and poly or synthetic material, of suitable thickness, weight, and dimensions.

In various embodiments, the stock material units may include an attachment mechanism that may connect multiple units of stock material (e.g., to produce a continuous material feed from multiple discrete stock material units). Preferably, the adhesive portion facilitates daisy-chaining the rolls together to form a continuous stream of sheet material that can be fed into the converting station 70.

Generally, the stock material 19 may be provided as any suitable number of discrete stock material units. In some embodiments, two or more stock material units may be connected together to provide a continuous feed of material into the dunnage conversion machine that feeds through the connected units, sequentially or concurrently (i.e., in series or in parallel). Moreover, as described above, the stock material units may have any number of suitable sizes and configurations and may include any number of suitable sheet materials. Generally, the term “sheet material” refers to a material that is generally sheet-like and two-dimensional (e.g., where two dimensions of the material are substantially greater than the third dimension, such that the third dimension is negligible or de minimus in comparison to the other two dimensions). Moreover, the sheet material is generally flexible and foldable, such as the example materials described herein.

In some embodiments, the stock material units may have fanfold configurations. For example, a foldable material, such as paper, may be folded repeatedly to form a stack or a three-dimensional body. The term “three-dimensional body,” in contrast to the “two-dimensional” material, has three dimensions all of which are non-negligible. In an embodiment, a continuous sheet (e.g., sheet of paper, plastic, or foil) may be folded at multiple fold lines that extend transversely to a longitudinal direction of the continuous sheet or transversely to the feed direction of the sheet. For example, folding a continuous sheet that has a substantially uniform width along transverse fold lines (e.g., fold lines oriented perpendicularly relative to the longitudinal direction) may form or define sheet sections that have approximately the same width. In an embodiment, the continuous sheet may be folded sequentially in opposite or alternating directions to produce an accordion-shaped continuous sheet. For example, folds may form or define sections along the continuous sheet, which may be substantially rectangular.

For example, sequentially folding the continuous sheet may produce an accordion-shaped continuous sheet with sheet sections that have approximately the same size and/or shape as one another. In some embodiments, multiple adjacent section that are defined by the fold lines may be generally rectangular and may have the same first dimension (e.g., corresponding to the width of the continuous sheet) and the same second dimension that is generally along longitudinal direction of the continuous sheet. For example, when the adjacent sections are contacting one another, the continuous sheet may be configured as a three-dimensional body or a stack (e.g., the accordion shape that is formed by the folds may be compressed, such that the continuous sheet forms a three-dimensional body or stack).

It should be appreciated that the fold lines may have any suitable orientation relative to one another as well as relative to the longitudinal and transverse directions of the continuous sheet. Moreover, the stock material unit may have transvers folds that are parallel one to another (e.g., compressing together the sections that are formed by the fold lines may form a three-dimensional body that is rectangular prismoid) and may also have one or more folds that are non-parallel relative to the transvers folds.

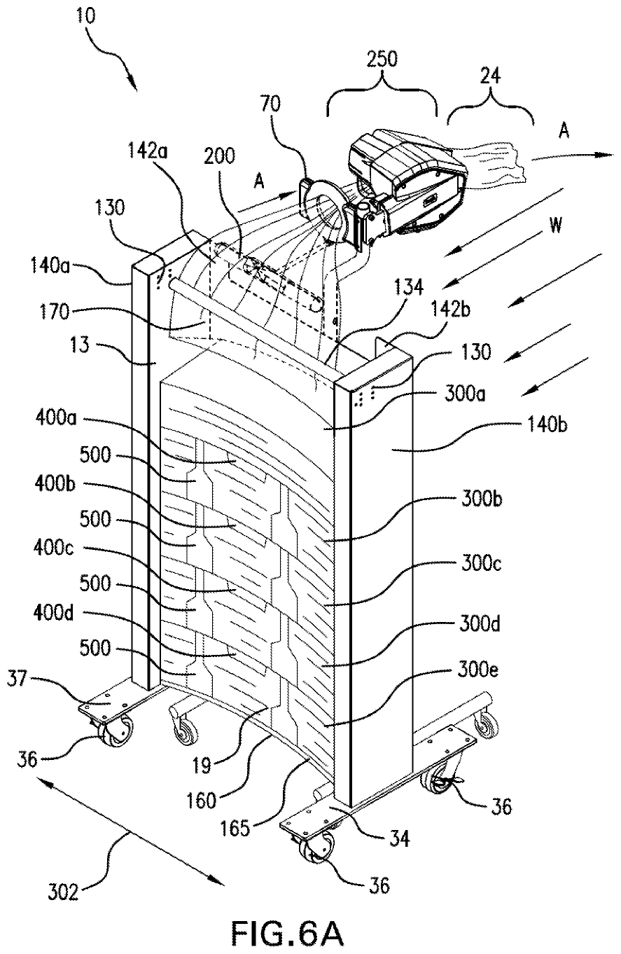

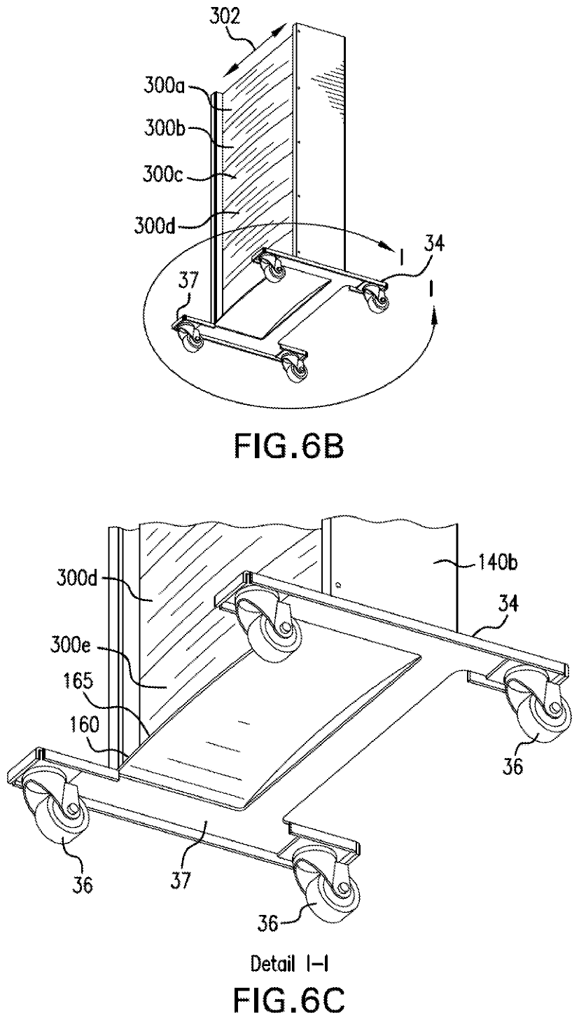

Folding the continuous sheet at the transvers fold lines forms or defines generally rectangular sheet sections. The rectangular sheet sections may stack together (e.g., by folding the continuous sheet in alternating directions) to form the three-dimensional body that has longitudinal, transverse, and vertical dimensions. As described above, the stock material from the stock material units may be fed through the intake 70 (FIGS. 1A, 1B, and 2). In some embodiments, the transverse direction of the continuous sheet (e.g., direction corresponding to the transverse dimension 302 (see, e.g., FIGS. 6A and 7A)) is greater than one or more dimensions of the intake 70. For example, the transverse dimension of the continuous sheet may be greater than the diameter of a generally round intake. For example, reducing the width of the continuous sheet at the start thereof may facilitate passage thereof into the intake. In some embodiments, the decreased width of the leading portion of the continuous sheet may facilitate smoother entry and/or transition or entry of a daisy-chained continuous sheet and/or may reduce or eliminate catching or tearing of the continuous sheet. Moreover, reducing the width of the continuous sheet at the start thereof may facilitate connecting together or daisy-chaining two or more stock material units. For example, connecting or daisy-chaining material with a tapered section may require smaller connectors or splice elements than for connecting a comparable sheet of full width. Moreover, tapered sections may be easier to manually align and/or connect together than full-width sheet sections.

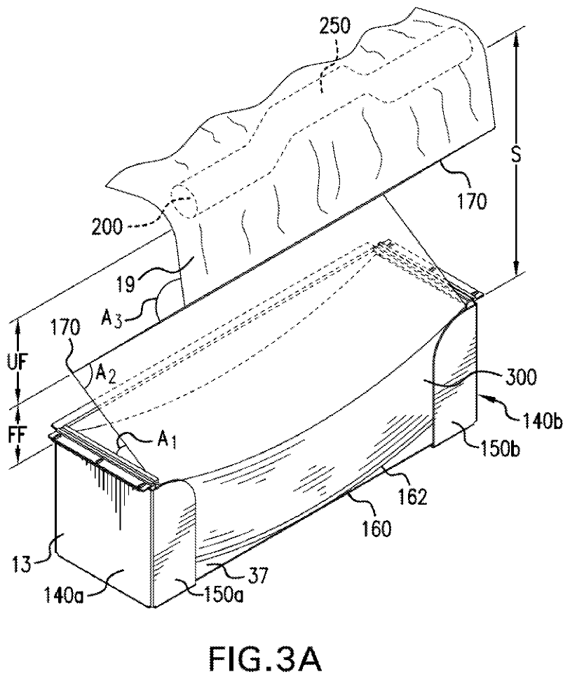

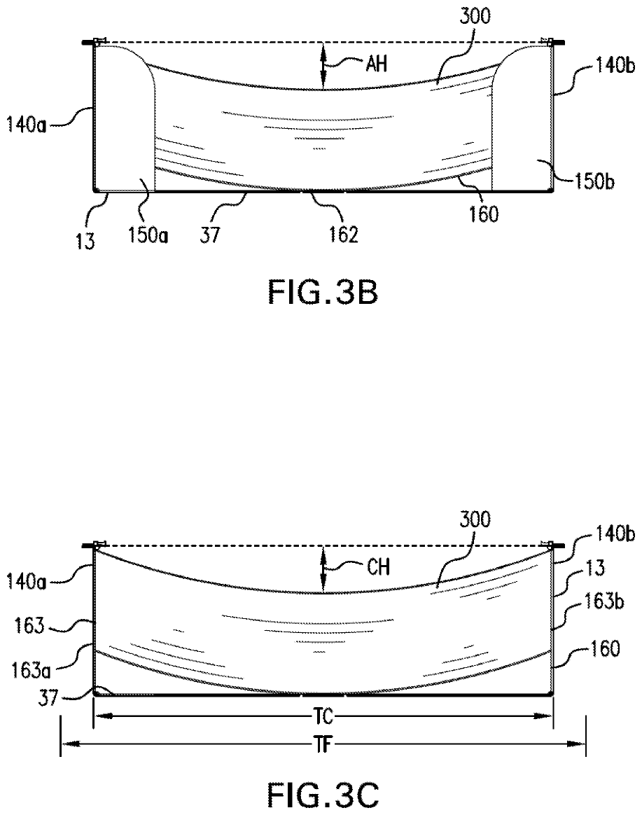

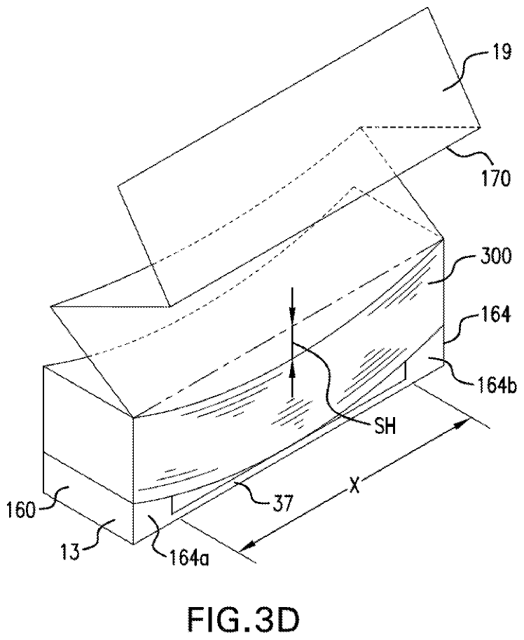

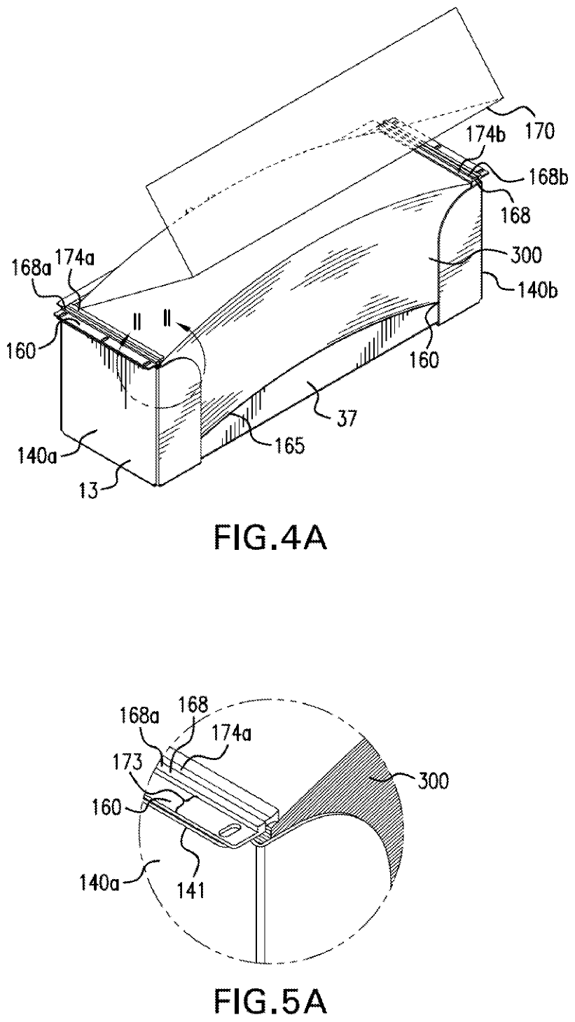

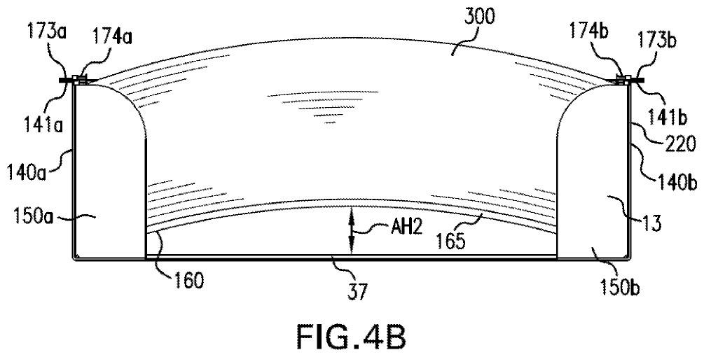

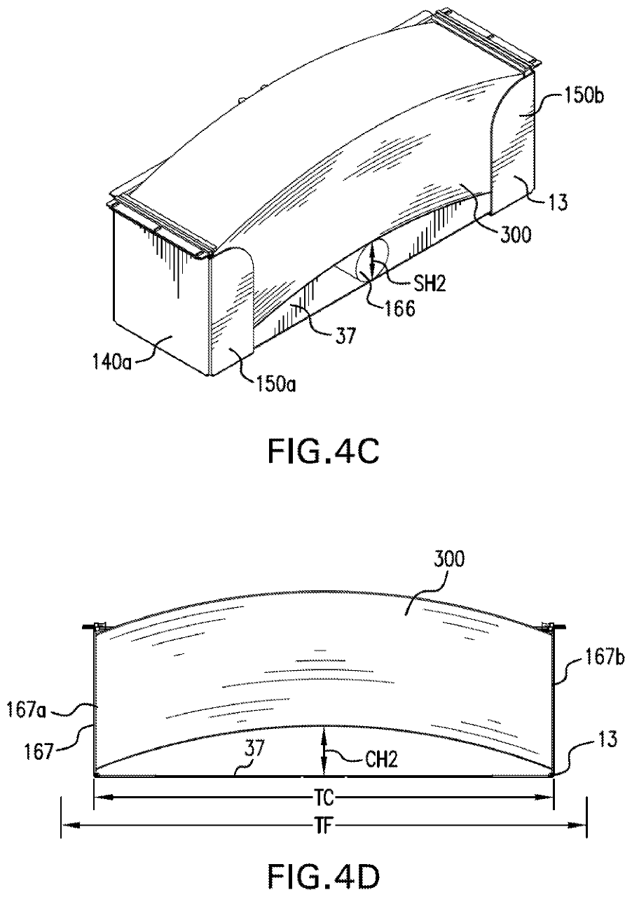

As described above, the dunnage conversion machine may include a supply station (e.g., supply station 13 (FIGS. 1A-1C)). In accordance with various embodiments, the supply station 13 is any structure suitable to support the stock material 19 and allow the material to be drawn into the intake 70. For example, the supply station 13 can be a surface. In other examples, as illustrated in FIGS. 3A-3C, the supply station 13 is a cart 34 that is separately movable relative to the dunnage conversion machine 100. In various other examples, as illustrated in FIGS. 4A-4B, the supply station 13 is mounted to the dunnage conversion machine 100. For example, the supply station 13 may be mounted to the dunnage conversion machine 100 support portion 12, such as the stand shown in FIGS. 7A-B. In such embodiments, the dunnage conversion machine 100 and the supply station 13 do not move relative to one another. In other embodiments, the supply station 13 and the dunnage conversion machine 100 may be fixed relative to one another but not mounted to each other, or the supply station 13 and the dunnage conversion machine 100 may move relative to one another while being mounted together. Regardless, the supply station may support the stock material 19 in one or more units. FIGS. 1A-C and 6A-6C illustrate the supply station 13 supporting a plurality of stock material units, e.g., units 300a, 300b, 300c, 300d, and/or 300e. FIGS. 4A-4B illustrate the supply station 13 supporting a single stock material unit 300. It should be noted, however, that support member 220 may support a plurality of units and/or the cart 34 may support a single unit. Each of the stock material units 300a, 300b, 300c, 300d, and/or 300e may be placed into the supply station 13 individually and subsequently may be connected together after placement. Hence, for example, each of the stock material units 300a, 300b, 300c, 300d, and/or 300e may be suitability sized to facilitate lifting and placement thereof by an operator. Moreover, any number of stock material units may be connected or daisy-chained together. For example, connecting together or daisy-chaining multiple stock material units may produce a continuous supply of material.

Since dunnage material is formed in a variety of locations, including the open layout of large warehouse spaces, wind, breezes, drafts, forced ventilation, or other significant air flow W (see, e.g., FIGS. 6A and 7A) from manmade or natural sources is a common occurrence. Such air flow W presents a distinct problem for the feeding of stock material. Generally W blows from the direction of the dunnage machine toward the supply station as shown. In some situations it may blow in other directions as well, such as from the supply station toward the dunnage machine. Regardless of the direction, the disclosure herein is beneficial to controlling the stock material and reducing run-out. Specifically, exposed portions of the material strung between the supply station 13 and the intake can get caught by the air flow W. This exposed portion of the material forms a sail S that is susceptible to capturing a significant amount of air flow that can pull extra material off the fanfold stack and away from the dunnage machine under sufficient air flow W. The more material pulled off of the fanfold stack, the larger the sail S becomes causing significant amounts of the material to blow away from the conversion machine creating a run-out of material. The straight folds/edges of traditional stacks of fanfold paper are held flat. These flat folds/edges in traditional stacks unfold easily. The presence of air flow W these flat folds/edges allow significant run-out. In accordance with various embodiments discussed herein, the supply station 13 includes an anti-runout apparatus 160 that influences the stack of fanfold paper such that run-out due to wind is limited. In accordance with various embodiments, the anti-runout apparatus 160 manipulates the fanfold material proximal to or below the bottom of the sail S. For example, the anti-runout apparatus manipulates how fanfold material is dispensed off the stock supply stack of fanfold material and/or manipulates the fanfold material proximal to or below the bottom of the sail S in order to limit run-out of the material caused by air flow W. As used herein, “proximal to the bottom of the sail S” defines a range of locations extending from the lowest point on the stock material affected by air flow W and then extending to a distance away from that point that is sufficiently small such that the force cause by air flow W creating run-out over this distance is minimal or non-existent, meaning that there is negligible exposure of material to the flow of air over this distance.

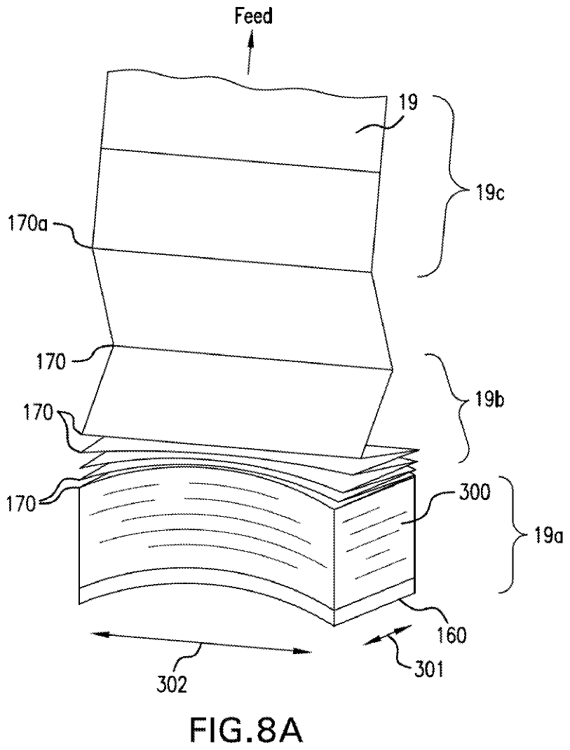

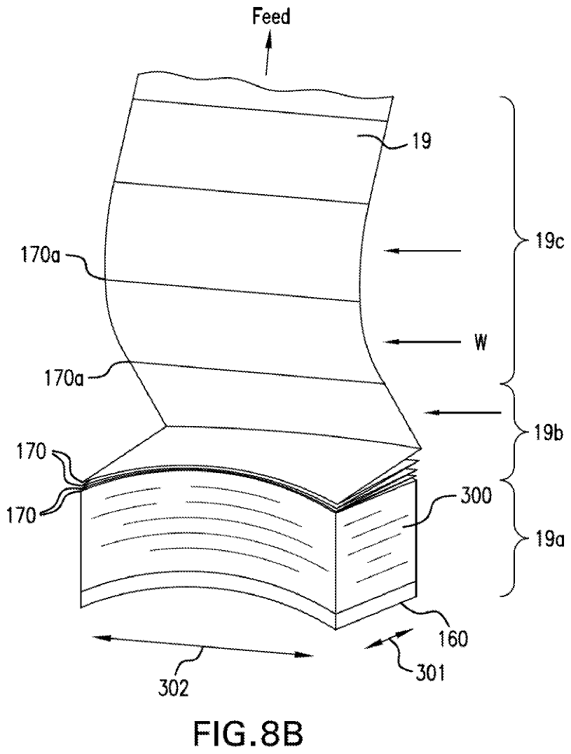

FIGS. 8A-8B illustrate an anti-runout apparatus 160 with a stack of fanfold material 300 positioned thereon. FIGS. 8A-8B are provided to illustrate the theoretical basis for why the system limits or eliminates the runout of the fanfold material caused by air flow W. It should be understood that the beliefs or understandings as to why the various systems herein limit the tendency of the fanfold material to run out due to air flow W, as provided herein, should not and do not limit the scope of the disclosure in any way, but are merely presented as a possible explanation of the effect of the system. FIG. 8A illustrates the fanfold material being extruded from the stack 300 vertically, out of the presence of air flow. The example illustrates three different phases of the material 19: a folded portion 19a, a transition portion 19b (i.e., an unfolding portion), and an unfolded portion 19c. The folded portion 19a includes the material that is still a part of the stack 300 that has not yet been unfolded in the longitudinal direction (i.e., bends 170) or un-bent in the transverse direction. This material is positioned in a non-planar state by the anti-runout apparatus 160 causing the bend in the transverse direction. The transition portion 19b includes the material that is being unfolded and un-bent immediately adjacent to the top of the stack of material. In this transition portion, the material is relaxed from having the complex shape (i.e., the transverse bend and the longitudinal fold defining the complex shape). Because pulling in the feed direction allows the relaxation, the material can be pulled in the feed direction with significantly less force than compared with the lateral direction 301. The unfolded portion 19c includes the material that no longer holds the complex shape and can be readily delivered to the dunnage machine. Creases 170a are shown in the unfolded portion since creases remain from where the material 19 was previously folded along folds 170. As shown in FIG. 8B, air flow W can flow laterally across the material. The bend across the transverse direction of the material formed by the anti-runout apparatus 160 causes the bend across the length of the folds 170 in the transition portion 19b and the folded portion 19a. Until this bend is flattened, the bend limits the ability of folds 170 to open. Pulling in the feed direction gradually opens both bends, but any force in the lateral direction 301 has the tendency to only open the folds 170 without relaxing the bend caused by the anti-runout apparatus 160. Thus, the air flow W has the tendency to only open the folds 170 without relaxing the bend caused by the anti-runout apparatus 160. With the complex shape still in place, fold 170 resists opening and therefore resists allowing the stock material.

In one example of the shape manipulating anti-runout apparatus 160, as illustrated in FIGS. 3A-3D, the unit of stock material 300 has a transverse non-planar configuration that is concave downstream (i.e., concave in the direction that the stock material is pulled toward the dunnage machine). In such an example, the unit of stock material 300 is supported on a support structure portion of the anti-runout apparatus 160 such that a transverse bend is formed across the transverse direction T of the material. This bend/arch is formed generally perpendicular to the folds 170 that form the accordion shape of the fanfold stock material. While the bend can face a variety of directions, FIGS. 3A-3D illustrate the bend is concave in the downstream direction. This configuration has folds in the fanfold bent, creating a complex shape that resists the unbending/unfolding of the fanfold material off the top of the stack.

FIG. 3A illustrates a supply station that holds a stack of fanfold stock material. The fanfold stock material is able to be withdrawn from the top of the stack of fanfold stock material. The stock material includes a fan folded portion FF at and proximal to the stack of fanfold stock material. The stock material also includes an unfolded portion UF extending away from the folded portion of the stock material. The supply station holds the stack of fanfold stock material so the stack of fanfold stock material assumes a non-planar configuration that resists run-out from air currents blowing on the unfolded portion UF of the stock material. As the stock material transitions from the fanfold portion FF to the unfolded portion UF the fold lines 70 tend to flatten out making the material easier to manipulate. In the fan folded state that material resists being unfolded due to the complex bending in the fold lines. For example, folds having an angle from 0° to 45° between adjacent sections of fan folded segments can be considered to be the fanfold portion FF of the stock material. As shown in FIG. 3A, angles A1 and A2 fall within this range and as such are considered to be fan folded. Angle A3 is greater than 45° and is considered to be a part of the unfolded portion of the stock material. This unfolded portion is drawn into the dunnage machine for conversion into low-density dunnage.

In accordance with one embodiment, as illustrated in FIG. 3B, the support structure includes a surface 162 having a curvature that defines at least a portion of the transverse bend (i.e., arch) in the unit of stock material stack 300. The curvature of the surface 162 may be shaped to provide the downstream concave configuration to the unit of stock material stack 300. For example, the surface 162 may have a curvature that is concave in the downstream direction. Additionally, the curvature of the surface 162 may be such that the surface 162 and the unit of stock material stack 300 can conform to one another (i.e., the curvature of the surface does not exceed the highest potential curvature of the unit of stock material stack 300). In some examples, the surface 162 may extend the entire width of the unit of stock material stack 300. In other examples, the surface 162 may extend only a portion of the width of unit of stock material stack 300, such as only supporting the outer transverse ends of the unit of stock material stack 300. In various examples, the support structure is an arched sheet of material (e.g., metal, polymer, wood, cardboard, etc.) having one side (i.e., the surface 162) configured to contact the unit of stock material stack 300. In various examples, the support structure is a three-dimensional structure of material (e.g., metal, polymer, wood, composite, etc.) having one side (i.e., the surface 162) configured to contact the unit of stock material stack 300. The curvature of the surface forms an arch height AH that is less than 50% and more than 5% of the transverse width of the unit of stock material stack 300 measured in a flat configuration. Preferably, the AH is about 10-40% of the transverse width of the unit of stock material stack 300 measured in a flat configuration. More preferably, the AH is about ⅓ of the transverse width of the unit of stock material stack 300 measured in a flat configuration. In a specific example, the deflection AH is at least 3 inches up to 12 inches on a 30 inch wide stack and 2 inches to 6 inches on a 15 inch wide stack of material.

In accordance with one embodiment, as illustrated in FIG. 3C, the support structure 163 includes vertical walls that are positioned relative to the unit of stock material stack 300. The vertical walls may have a transverse width TC that is less than the transverse flattened width TF of the unit of stock material stack 300 in a flat planar configuration. In order to fit the unit of stock material stack 300 between the walls of the support structure 163, the unit of stock material stack 300 would be curved such that the width of the curved stock material is the transverse width TC. In this way, merely placing the unit of stock material stack 300 between the walls 163a and 163b of the support structure 163 has a tendency to place a transverse bend/arch in the unit of stock material stack 300. As shown in FIG. 3C, this bend may be concave in the downstream direction. In this example, the walls include a structure sufficiently strong to withstand the transverse force of the curved stack of material. As discussed herein, in some embodiments, multiple units of stock material may be stacked on top of each other and, as such, the walls of the support structure 163 are correspondingly strong to withstand the transverse force of the curved multiple units of stacked material. The walls of the support structure 163 may collapse the material to a collapsed height CH that is less than 50% and more than 5% of the transverse width of the unit of stock material stack 300 measured in a flat configuration. Preferably, the CH is about 10-40% of the transverse width of the unit of stock material stack 300 measured in a flat configuration. More preferably, the CH is about ⅓ of the transverse width of the unit of stock material stack 300 measured in a flat configuration. In a specific example, the deflection CH is at least 3 inches up to 12 inches on a 30 inch wide stack and 2 inches to 6 inches on a 15 inch wide stack of material.

The various support structures discussed above can cause a continuous bend in the stack 300, or a localized bend (i.e. near the transverse edges) sufficient to prevent or limit run-out of the fanfold material due to air flow catching the sail. The narrow walls and flat bottom would be an example of localize bend near the edges. A curved base such surface 162 has can be configured to provide a desired bend shape. The radius can also be constant or it can change. For example, the radius of curvature can be smaller in certain parts than others.

In accordance with one embodiment, as illustrated in FIG. 3D, the support structure includes outer supports 164 having a sufficient separation X between the outer supports 164a and 164b to cause the unit of stock material stack 300 to sag under its own weight, resulting in a bend/arch between the outer supports 164. The bend between two outer supports 164 is sufficient to provide a downstream concave configuration to the unit of stock material stack 300. The sag in the material may have a sag height SH that is less than 50% and more than 5% of the transverse width of the unit of stock material stack 300 measured in a flat configuration. Preferably, the SH is about 10-40% of the transverse width of the unit of stock material stack 300 measured in a flat configuration. More preferably, the SH is about ⅓ of the transverse width of the unit of stock material stack 300 measured in a flat configuration. The height of the outer supports 164 is approximately the SH.

In another example of the shape manipulating anti-runout apparatus 160, as illustrated in FIGS. 4A-4D, the unit of stock material 300 has a transverse non-planar configuration that is convex downstream (i.e., convex in the direction that the stock material is pulled toward the dunnage machine). In such an example, the unit of stock material 300 is supported on a support structure portion of the anti-runout apparatus 160 such that a transverse bend is formed across the transverse direction T of the material. Similar to the bend/arch in the previous example, the bend/arch shown in FIGS. 4A-4D is formed generally perpendicular to the fold lines 170 that form the accordion shape of the fanfold stock material. As illustrated in FIGS. 4A-4D, the bend/arch is convex in the downstream direction. Various support structures can form the bend and are discussed in more detail below.

In accordance with one embodiment, as illustrated in FIG. 4B, the support structure includes a surface 165 having a curvature that defines at least a portion of the transverse bend (i.e., arch) in the unit of stock material stack 300. The curvature of the surface 165 may be shaped to provide the downstream convex configuration to the unit of stock material stack 300. Additionally, the curvature of the surface 165 may be such that the surface 165 and the unit of stock material stack 300 can conform to one another (i.e., the curvature of the surface does not exceed the highest potential curvature of the unit of stock material stack 300). In some examples, the surface 165 may extend the entire width of the unit of stock material stack 300. In other examples, the surface 165 may extend only a portion of the width of unit of stock material stack 300, such as only supporting the outer transverse ends of the unit of stock material stack 300. In various examples, the support structure is an arched sheet of material (e.g., metal, polymer, wood, cardboard, etc.) having one side (i.e., the surface 165) configured to contact the unit of stock material stack 300. In various examples, the support structure is a three-dimensional structure of material (e.g., metal, polymer, wood, composite, etc.) having one side (i.e., the surface 165) configured to contact the unit of stock material stack 300. The curvature of the surface forms an arch height AH2 that is less than 50% and more than 5% of the transverse width of the unit of stock material stack 300 measured in a flat configuration. Preferably, the AH2 is about 10-40% of the transverse width of the unit of stock material stack 300 measured in a flat configuration. More preferably, the AH2 is about ⅓ of the transverse width of the unit of stock material stack 300 measured in a flat configuration.

In accordance with one embodiment, as illustrated in FIG. 4C, the support structure includes an internal support 166 which is positioned within the supply station 13 to elevate an internal portion (e.g., center portion) of the unit of stock material stack 300 relative to the transverse end portions. This allows the transverse end portions to sag under their own weight, resulting in a bend/arch over the internal support 166. The bend formed by support 166 is sufficient to provide the downstream convex configuration to the unit of the stock material stack 300. In some embodiments, the internal support 166 may be a rib that extends from a bottom plate of the supply station 13. In other examples, as shown in FIG. 4C, the internal support 166 may include a cantilever member such as a dowel that extends from a front wall of the supply station 13. The sag of the transverse end portions relative to the support height can be defined as the sag height SH. In various examples, the sag height is less than 50% and more than 5% of the transverse width of the unit of stock material stack 300 measured in a flat configuration. Preferably, the SH2 is about 5-30% of the transverse width of the unit of stock material stack 300 measured in a flat configuration. More preferably, the SH2 is about 10-20% of the transverse width of the unit of stock material stack 300 measured in a flat configuration. The height of the internal supports 166 is approximately the SH2.

In accordance with one embodiment, as illustrated in FIG. 4D, the support structure 167 includes vertical walls 167a and 167b that are positioned relative to the unit of stock material stack 300 and preferably on the transverse ends thereof. The walls of the support structure 167 may have a transverse width TC2 that is less than the transverse flattened width TF2 of the unit of stock material stack 300 in a flat planar configuration. In order to fit the unit of stock material stack 300 between the walls 167a and 167b of the support structure 167, the unit of stock material stack 300 would be curved such that the width of the curved stock material is the transverse width TC2. In this way, merely placing the unit of stock material stack 300 between the walls of the support structure 167 has a tendency to place a transverse bend/arch in the unit of stock material stack 300. As shown in FIG. 4D, this bend may be convex in the downstream direction. In this example, the walls include a structure sufficiently strong to withstand the transverse force of the curved stack of material. As discussed herein, in some embodiments, multiple units of stock material may be stacked on top of each other and, as such, the walls of the support structure 167 are correspondingly strong to withstand the transverse force of the curved multiple units of stacked material. The walls of the support structure 167 may arch the material to a height CH2 that is less than 50% and more than 5% of the transverse width of the unit of stock material stack 300 measured in a flat configuration. Preferably, the CH2 is about 10-40% of the transverse width of the unit of stock material stack 300 measured in a flat configuration. More preferably, the CH2 is about ⅓ of the transverse width of the unit of stock material stack 300 measured in a flat configuration.

It should be appreciated that the various examples of support structures described herein may be used individually or may be combined with other examples of support structures to provide the desired strength or functionality that a user may seek in implementing the system.

In another example of the anti-runout apparatus, the transverse non-planar configuration is defined by more than one arch in the unit of stock material, with the structure being concave in both the upstream and downstream directions across the transverse width of the unit of stock material. In this way, the unit of stock material may have a transverse wave or other shape that causes one or more transverse bends in folds that form the accordion shape of the fanfold stock material.

In each of the examples above, the transverse widths and therefore the lengths of the folds 170 (as shown, for example, in FIGS. 3A and 4A) in the unit of stock material 300 are bent forming complex bends (i.e., bends in multiple directions) along each of the fold lines 170. These complex bends tend to add structure to the shape of the fan folded material, meaning that each of the folds in the material have a tendency to maintain a folded configuration. As a result, the complex bends resist the unfolding of the material as it is withdrawn from the stack. This resistance limits the ability of air flow W across the material to cause a run-out in the material.

In accordance with some embodiments, the stock supply station 13 includes the anti-runout apparatus 160. In these embodiments, the anti-runout apparatus 160 is in part configured to manipulate the resistance applied to one or more portions of the unit of stock material 300 as fan fold material is pulled off of the top of the stack. As discussed above, one method to manipulate the resistance against the fan fold material as it is pulled off the top of the stack is to form complex bends along the fold lines. In this way the shape applies some resistance. In other embodiments, however, the resistance may be manipulated in other ways in addition to or as an alternative to manipulating the shape of the unit of stock material 300. For example, the anti-runout apparatus 160 can apply a drag to the fanfold material as it is pulled off of the unit of stock material 300 and into or toward the dunnage machine 100. To do this, the anti-runout apparatus 160 includes, in various embodiments, a resistance structure that applies a drag to one or more portions the unit of stock material 300 as fan fold material is pulled off of the top of the stack or as the fan fold material is exposed to air flow W prior to or proximal to the sail S portion.

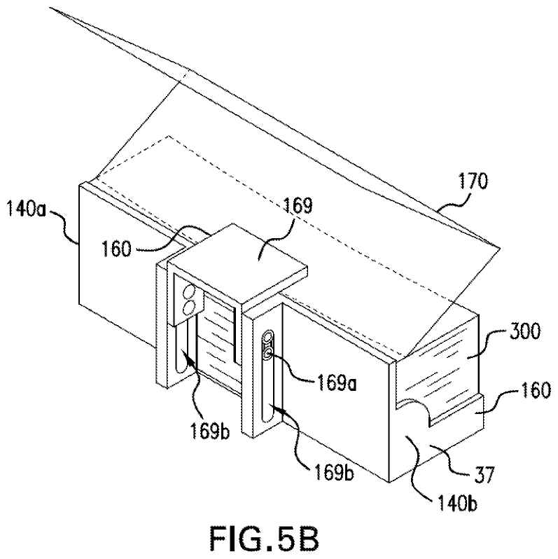

In one example, the anti-runout apparatus 160 manipulates resistance by including a resistance structure 168. In accordance with one embodiment, as shown in FIG. 5A, the resistance structure 168 includes two or more members 168a and 168b located on transverse ends of the supply station 13. In this embodiment, the supply station 13 includes side walls 140a and 140b. The side walls 140a and 140b may extend at least the height of the unit of stock material 300. The two resistance members 168a and 168b are located along the side walls 140a and 140b. As shown in FIG. 5A, the side walls 140a and 140b may be the same height as the unit of stock material 300 with the two resistance members 168a and 168b positioned at the top of the wall. The resistance members 168a and 168b may be cantilevered inward from the top of the walls (i.e., toward each other) such that the resistance members 168a and 168b interfere with the path of the stock material as it is pulled up off of the unit of stock material 300. In one example, the cantilevered ends 174a and 174b are rigid. The rigidity forces the stock material to deform around the ends in order to get past them. The ends 174a and 174b may be rigid portions of metal, polymer, composite, or other material that is sufficiently smooth to allow the stock material around the ends 174a and 174b. In another example, the cantilevered ends 174a and 174b are flexible. The flexibility allows the cantilevered ends 174a and 174b to deform to the stock material or for the stock material to deform around the ends or a combination of both the stock material and the ends deforming in order for the stock material to get past the ends. The flexible ends may be formed from a singular structure such as a continuous flexible elastomer, rubber, fiber, or other material with similar flexibility. Alternatively, the flexible ends may be formed from a plurality of structures, having, for example, one, two, three, or more sections. In another example, the structure may be formed like a brush. In these embodiments, the resistance member 168 biases or aids in biasing the fanfold material into holding its folded form. This biasing limits the ability of air flow W to blow the fanfold material off the top of the stack, helping to prevent run-out.

In one example, the anti-runout apparatus 160 manipulates resistance by including a central resistance member 169. In accordance with one embodiment, as shown in FIG. 5B, the central resistance member 169 extends from the supply station 13 over an interior portion of the unit of stock material 300 (e.g., the middle of the fanfold stack). In this embodiment, the supply station 13 may include one or more walls. The wall may extend at least the height of the unit of stock material 300. The resistance member 169 can be attached to a base member or one or more of the walls. A force-exerting portion of the resistance member 169 may extend (e.g., be cantilevered) inward over the top of the center portion of the unit of stock material 300. The resistance member 169 is accordingly positioned to interfere with the path of the stock material as it is pulled up off of the unit of stock material 300. The force-exerting portion of the resistance member biases the stock material to maintain its folded form. In various examples, the force-exerting portion of the resistance member 169 is rigid. The portion can be formed from metal, polymer, composite, or other material that is sufficiently smooth to allow the stock material around the end of the portion to flow up to the dunnage machine 100. In another example, the force-exerting portion of the resistance member 169 is flexible. The flexibility allows the force-exerting portion of the resistance member 169 to deform to the stock material or for the stock material to deform around the end of the force-exerting portion of the resistance member 169 or a combination of both. In any of these embodiments, the resistance member 169 biases or aids in biasing the fanfold material into holding its folded form. Alternatively, the downward force from the force-exerting portion applies resistance to movement of the material, thereby reducing the ability of airflow to run out the material. The biasing by the resistance member 169 limits the ability of air flow W to blow the fanfold material off the top of the stack, helping to prevent run-out. In one example, the resistance member 169 may be connected to a track 169b via a plurality of engagement members 169a (e.g. studs). The weight of the resistance member 169 may allow it to slide down the track and accommodate and add a force against the stock material stack regardless of the height of the stack.

As illustrated in the various embodiments herein, the anti-runout mechanisms 160 can function by manipulating the shape of the material without interferences with the material, such as edge interferences. In other embodiments, the resistance members may provide a single-edge interference, two edge interferences (e.g., resistance mechanism 174a/b), or more edge interferences.

In accordance with various embodiments, the stock supply 13 is a movable storage container. For example, the stock supply 13 may form a part of a cart 34. In this way, the stock supply 13 may move relative to the dunnage conversion machine 100. Either one or both of the stock supply 13 and the dunnage conversion machine 100 can be supported on casters, wheels, gliders, runners, or similar movement devices. For example, the stock supply cart 34 includes casters 36 that allow the stock supply cart 34 to be wheeled toward or away from the dunnage conversion machine 100. In accordance with various embodiments, the movement devices (e.g., casters 36) are mounted to a base 37. The base 37 may include or be defined by the anti-runout apparatus 160, as shown for example in FIG. 6A, where support structure 165 (e.g., arched plate as shown) bridges between two transverse sides of the base 37 from which casters 36 extend. FIGS. 6B and 6C illustrate bottom views of a similar structure. In the embodiment illustrated in FIGS. 6A-C, the support structure 165 is either the primary or only support for the magazine full of units of stock material 300a-e. In other embodiments, such as those shown in FIG. 4A, a base may extend below the support structure 165. The other embodiments of support structures used in the anti-runout apparatus 160 disclosed herein may be in accordance with either of these embodiments of the base 37.

Upright supports or alternatively walls 140a, 140b extend from the base 37. In some embodiments, the interior surfaces of the walls 140a, 140b provide the support against the units of stock material discussed above with regard to the various support structures (e.g., 163 and 167) that are configured for manipulating the shape of the unit of stock material 300. In other embodiments, the walls 140a, 140b support and/or form other features of the cart 34 apart from the support structure of the anti-runout apparatus 160. For example, as shown in FIGS. 1A-C the front vertical supports/walls 142a, 142b and/or the rear supports/walls 150a and 150b may extend from the walls 140a, 140b. In other embodiments, the front vertical supports/walls 142a, 142b and/or the rear supports/walls 150a and 150b may extend from the base. Although shown as separate portions, the front vertical supports/walls 142a, 142b may be a single wall. Similarly, the rear supports/walls 150a and 150b can be a single wall. One or more sets of the vertical supports/walls may be adjustable such that they open and close like rear supports/walls 150a and 150b. In other embodiments, as shown in FIGS. 6A-C the cart may only have one set of vertical supports/walls such as the front vertical support/walls 142a, 142b leaving the cart open for loading. In some embodiments, the cart 13 may also include a guide bar 134 that is positioned to redirect the stock material 19 as the stock material 19 is pulled from a unit of stock material (e.g. 300a) and into the drive mechanism 250 of the dunnage machine 100. In some embodiments disclosed herein, for example in FIGS. 1A, 4A, and 4B, the walls 140a and 140b, which are parallel and are opposed to one another to support opposite transverse ends of a stack of stock material 300.

While cart 34 is described above as a movable embodiment of the supply station 13, the supply station 13 may also be mounted directly to the dunnage machine 100. In such embodiments, the various aspects of the cart 34 discussed above may be applied absent the separate movement elements (e.g., casters 36). In accordance with another embodiment, however, the supply station 13 may be configured to support fewer units of stock material 300, such as one, two, or three units. For example, the supply station 13 may be a support container 220 having transverse walls 140a/140b, a base 37, rear supports 150a/150b, and/or a front support 142. The support container may also have an anti-runout mechanism 160, as discussed, with regard to any of the embodiments above. In various embodiments, the support container 220 may have an attachment member 176 configured to connect to the stand 12 of the dunnage machine 100. In one example, the attachment member 176 may be a tab extending from the support container 220 with a profile that conforms to the outside of the stand 12 such that the tab extends around the stand 12. The stand may include a shelf suitable to support the tab, thereby supporting the support container 220. Container 220 may also have a connection element for fastening the container 220 to the stand 12. For example, the connection element may be aperture 177. It is appreciated that other elements may be used.

In accordance with various embodiments, as illustrated in FIG. 7C, the container 220 may include other such features so as to accommodate the various aspects and embodiments of the elements discussed above. For example, the side walls 140a and 140b may have outwardly extending flanges 141a and 141b that support the resistance member 168 and, more specifically, a mounting portion 173a/173b of the resistance member 168a. The mounting portions and the flanges may have their own connection members for connecting to one another. For example, they may have slotted apertures 171 suitable to receive fasteners. The slotted apertures 171 may allow for adjustment between the flange 141a/141b and the mounting portion 173a/173b.

With the support container 220 mounted directly to the stand 12, the distance between the support container 220 and the guide 200 can be modified so that the combination of the height and the anti-runout mechanism 160 is suitable to minimize or eliminate run-out due to air flow W blowing through the sail portion of the stock material 19.

In one embodiment, the anti-runout apparatus 160 includes a support structure 162. The support structure 162 is positioned below the fanfold stack 19. In embodiments of the support structure 162 in which multiple units of material (e.g. 300a, 300b, etc.) are used, the support structure 162 is positioned below the lowest unit in the stack. As shown in FIGS. 1A-1B and 6A, the effects of the non-planar support structure 162 are progressively lost from the bottom unit to the top unit in the stack. However, it should be noted that the sail S formed by the top unit is much smaller than the sail S formed by the bottom unit and as such, the run-out limiting configuration of the unit can be minimized in the top unit compared to the bottom unit, which is in greater need of the run-out limiting configuration.

In accordance with various embodiments, the anti-runout apparatus 160 manipulates the resistance applied to the anti-runout of the fanfold material off the stack of stock material. While different embodiments of the anti-runout apparatus are shown with respect to the cart 34 and the support container 220, it should be appreciated that each of the different embodiments of the anti-runout apparatus can variously apply to either the cart 34 or the support container 220. Furthermore, the various embodiments of the anti-runout apparatus can be used individually or they can be combined with each other as is illustrated in the various figures (e.g. the walls 167 having a width narrower than the stock material is combined with the arched surface 165 and the resistance element 168 in FIG. 4A)

The non-planar configuration of the stock material is caused by a transverse bend in a stack or single sheet of the stock material. The transverse bend adds stiffness to the web of material making up the stock material. The added stiffness slows the blow-out of the stock material under high air flow W across the depth of the stack of stock material. The non-planar configuration is one example of a throttling device.

As described above, the dunnage conversion machine may include a supply station (e.g., supply station 13 (FIGS. 1A-2)). For example, each of the stock material units 300a and 300a′ may be placed into the supply station individually and subsequently may be connected together after placement. Hence, for example, each of the stock material units 300a-300e may be suitable sized to facilitate lifting and placement thereof by an operator. Moreover, any number of stock material units may be connected or daisy-chained together. For example, connecting together or daisy-chaining multiple stock material units may produce a continuous supply of material.

As described above, the stock material unit may include a continuous sheet that may be repeatedly folded to form or define a three-dimensional body or stack of the stock material unit. FIG. 6A illustrate folds 170 of a partially folded continuous sheet to produce a stock material unit 300b according to an embodiment. Except as described herein, the stock material unit 300c may be similar to the stock material unit 300b, which may be similar to the stock material unit 300a and so on. For example, a continuous sheet may be repeatedly folded in opposing directions, along transverse fold lines, to form sections or faces along the longitudinal direction of the continuous sheet, such that adjacent section may fold together (e.g., accordion-like) to form the three-dimensional body of each of the stock material unit 300.

The stock material units may include one or more straps that may secure the folded continuous sheet (e.g., to prevent unfolding or expansion and/or to maintain the three-dimensional shape thereof). For example, strap assemblies 500 may wrap around the three-dimensional body of the stock material unit, thereby securing together the multiple layers or sections (e.g., formed by accordion-like folds). The strap assemblies 500 may facilitate storage and/or transfer of the stock material unit (e.g., by maintaining the continuous sheet in the folded and/or compressed configuration). FIG. 6A illustrates unit's 300b-e showing the strap assemblies 500 and 300a shows the strap assemblies removed.

For example, when the stock material unit 300 is stored and/or transported, wrapping the three-dimensional body of the stock material unit 300 and/or compressing together the layers or sections of the continuous sheet that defines the three-dimensional body may reduce the size thereof. Moreover, compressing together the sections of the continuous sheet may increase rigidity and/or stiffness of the three-dimensional body and/or may reduce or eliminate damaging the continuous sheet during storage and/or transportation of the stock material unit 300.

Generally, the strap assemblies 500 may be positioned at any number of suitable locations along the transverse dimension of any of the stock material units 300. In the illustrated embodiment, the strap assemblies 500 are positioned on opposite sides of the unit. In some embodiments, and as illustrated in FIG. 6A, another stock material unit may be placed on top of each of the stock material units with 300a shown on top of 300b, such that the bottom section and/or portion of the continuous sheet of unit 300a contacts the exposed portion(s) of the stock material unit 300b. Generally, stock material units may be similar to or the same as one another. Moreover, a connector of a splice member that is included with the stock material unit 300a may be attached to the stock material unit 300b. For example, the connector adhesive layer of the connector that is attached to the stock material unit 300b may face outward or upward.

Moreover, as mentioned above, the stock material unit 300b may be the same as the stock material unit 300a. For example, the stock material unit 300b may include a connector that may be oriented to have an adhesive thereof face upward or outward. Hence, an additional stock material unit may be placed on top of the stock material unit 300b, such as to connect together the continuous sheet of the stock material unit 300b with the continuous sheet of another stock material unit (e.g. unit 300a). In such manner, any suitable number of stock material units may be connected together and/or daisy-chained to provide a continuous feed of stock material into the dunnage conversion machine.

In some embodiments, as discussed in detail above, the stock material unit 300 may be bent or have an arched shape. For example, unit 300e may be bent while unit 300a is flat. In some examples all units are bent or in other examples no units are bent. In the illustrated embodiment of FIG. 6A, the stock material units 300a-d include splice members 400a-d. The stock material unit 300a-d may be bent in the manner that protrudes the connector of the splice member 400a outward relative to other portions of the stock material unit 300a-d. The splice member 400a is configured to daisy chain unit 300a to unit 300b. The splice member 400b is configured to daisy chain unit 300b to unit 300c. The splice member 400c is configured to daisy chain unit 300c to unit 300c. The splice member 400d is configured to daisy chain unit 300d to unit 300e. In some examples, the stock material units may be bent after placement into the supply station 13 (e.g., the supply station may include an anti-runout mechanism 160 as discussed above. Stacking or placing another, additional stock material unit on top of the bent stock material unit may facilitate contacting the adhesive layer of the connector with the continuous sheet of the additional stock material unit. After the additional stock material is placed on top of the lower stock material unit, the additional stock material unit may conform to the shape of the lower stock material unit. The conforming may be complete (i.e. the upper unit may complete adapt the shape of the lower unit) or the conforming may be partial (i.e. the upper unit slightly conforms to the lower unit but remains flatter than the lower unit.)

The strap assemblies 500 may be spaced from each other along a traverse direction of the three-dimensional body of the stock material units. For example, the strap assemblies may be spaced from each other such that the center of gravity of the three-dimensional body is located between two strap assemblies 500. Optionally, the strap assemblies 500 may be equidistantly spaced from the center of gravity.

As described above, the stock material units 300a-e (or in some embodiments one unit 300 is used) may be placed into a dunnage conversion machine 100 forming the dunnage system 50. Additionally or alternatively, multiple stock material units (e.g., similar to or the same as the stock material unit 300) may be stacked on top of another in the dunnage conversion machine. The stock material unit may include one or more strap assemblies 500. For example, the strap assemblies 500 may remain wrapped about the three-dimensional bodies of the stock material units after placement and may be removed thereafter (e.g., the strap assemblies 500 may be cut at one or more suitable locations and pulled out).

Furthermore, it should be appreciated that, generally, the three-dimensional body of any of the stack material units described herein may be, stored, transported, used in a dunnage conversion machine, or combinations thereof without any wrapping (or strapping) or with more or different straps or wrappings than the strap assemblies discussed herein. For example, a twine, paper, shrink-wrap, and other suitable wrapping or strapping material may secure together one or more sheets that define the three-dimensional body of any of the stock material unit described herein. Similarly, the above-described method and structure of supporting the three-dimensional body of the stock material unit may facilitate wrapping or three-dimensional body with any number of suitable wrapping or strapping materials and/or devices. Further details of the strap assemblies 500 and the daisy chaining splice elements 400 are disclosed in application Ser. No. 15/593,007, entitled “Stock Material Units For A Dunnage Conversion Machine” filed concurrently herewith, which is incorporated herein by reference in its entirety.

By utilizing the strap assemblies 500 or similar banded wrapping, the units of stock material 300 are not forced into a transversely rigid configuration. Thus the strap assemblies 500 allow the units of stock material 300 to be transversely flexible or without transversely rigid support, thereby permitting the units of stock material 300 arch/sag or otherwise flex into a transversely nonplanar configuration.

One having ordinary skill in the art should appreciate that there are numerous types and sizes of dunnage for which there can be a need or desire to accumulate or discharge according to an exemplary embodiment of the present invention. As used herein, the terms “top,” “bottom,” and/or other terms indicative of direction are used herein for convenience and to depict relational positions and/or directions between the parts of the embodiments. It will be appreciated that certain embodiments, or portions thereof, can also be oriented in other positions. In addition, the term “about” should generally be understood to refer to both the corresponding number and a range of numbers. In addition, all numerical ranges herein should be understood to include each whole integer within the range.

While illustrative embodiments of the invention are disclosed herein, it will be appreciated that numerous modifications and other embodiments may be devised by those skilled in the art. For example, the features for the various embodiments can be used in other embodiments. The converter having a drum, for example, can be replaced with other types of converters. Therefore, it will be understood that the appended claims are intended to cover all such modifications and embodiments that come within the spirit and scope of the present invention.

1-22. (canceled)

23. A dunnage machine supply station, comprising:
a support including an arched surface; and
a plurality of walls extending adjacent to the support that contain a stack of fanfold stock material such that the fanfold stock material is able to be withdrawn from a first end of the stack by a dunnage conversion machine that converts the fanfold stock material into low-density dunnage;
wherein the arched surface has a height between 5% and 20% of a width of the stack of the fanfold stock material, the arched surface manipulating a shape of the fanfold stock material into a non-planar configuration, and
wherein the non-planar configuration causes fanfolds in the fanfold stock material to bend to resist unfolding upon pulling the fanfold stock material from the first end of the stack in a direction across the fanfolds and non-perpendicularly to the first end of the stack, thereby resisting runout from air currents blowing on an unfolded portion of the fanfold stock material that has been pulled off of the stack.

24. The dunnage machine supply station of claim 23, wherein the support manipulates the fanfold stock material into a shape that is convex in a downstream direction.

25. The dunnage machine supply station of claim 23, wherein the arched surface supports a bottom of the stack of the fanfold stock material.

26. The dunnage machine supply station of claim 25, wherein the arched surface is an arched piece of sheet material configured to support the fanfold stock material.

27. The dunnage machine supply station of claim 23, wherein two of the plurality of walls are separated by a distance that is narrower than the width of the fanfold stock material.

28. The dunnage machine supply station of claim 23, wherein the dunnage machine supply station supports a plurality of separate stacks of stock material with one or more of the separate stacks of stock material having a non-planar configuration.

29. The dunnage machine supply station of claim 28, wherein the plurality of separate stacks of stock material are daisy chained together.

30. The dunnage machine supply station of claim 28, wherein the arched surface forms a base surface of the dunnage machine supply station with the plurality of separate stacks of stock material stacked above the arched surface.

31. The dunnage machine supply station of claim 23, wherein the dunnage machine supply station includes a resistance mechanism that resists motion of the fanfold stock material as the fanfold stock material is removed from the stack of the fanfold stock material.

32. The dunnage machine supply station of claim 31, wherein the fanfold stock material includes a folded portion proximal to the stack and the unfolded portion extending away from the folded portion of the fanfold stock material, the dunnage machine supply station configured to hold the stack of the fanfold stock material such that the stack of the fanfold stock material assumes a non-planar configuration that resists run-out from air currents blowing on the unfolded portion of the fanfold stock material that has been pulled off of the stack of the fanfold stock material as the fanfold stock material is unfolded due to withdrawal from the dunnage machine supply station.

33. A dunnage system comprising:
the dunnage machine supply station of claim 23;
the fanfold stock material loaded into the dunnage machine supply station; and
a dunnage conversion machine that withdraws the fanfold stock material from the dunnage machine supply station and converts the fanfold stock material into low-density dunnage.

34. The dunnage machine supply station of claim 23, wherein two of the plurality of walls extend in a transverse direction over a portion of the width of the stack of fanfold stock material to support the stack, which two walls are adjustable to an open position to load the dunnage machine supply station, and a closed position to support respective outer transverse ends of the stack.

35. The dunnage machine supply station of claim 23, wherein:
the arched surface is arched in a transverse direction;
the support is positioned below the stack of the fanfold stock material, such that a second end of the stack, opposed to the first end, contacts the support and the weight of the stack of the fanfold stock material causes the stack to sag onto the arched surface thereby assuming the non-planar configuration; and
a first pair of the plurality of walls are parallel and opposed to one another to support transverse ends of the stack of the fanfold stock material along a height of the stack, which first pair of the plurality of walls extend upwardly from the support to contain the stack of the fanfold stock material, to allow the fanfold stock material of the stack that is supported on the support to be withdrawn from the first end of the stack.

36. A dunnage system comprising:
the dunnage machine supply station of claim 35, wherein the first pair of the plurality of walls extend upwardly to support a plurality of separate stacks of stock material; and
the plurality of separate stacks of stock material loaded into the dunnage machine supply station, wherein the arched surface manipulates the shape of a first stack of the plurality of separate stacks into the non-planar configuration and additional stacks of the plurality of separate stacks placed on top of the first stack conform to the shape of the first stack.

37. A dunnage system comprising:
the dunnage machine supply station of claim 23 configured to feed the fanfold stock material therefrom; and
a dunnage conversion machine that withdraws the fed fanfold stock material from the dunnage machine supply station and converts it into low density dunnage.

38. The dunnage system of claim 37 further comprising:
a plurality of stacks of the fanfold stock material loaded into the dunnage machine supply station, wherein the plurality of stacks are daisy chained together such that a first end of a first of the plurality of stacks is daisy chained to a second end of a second of the plurality of stacks; and
wherein the dunnage conversion machine is further configured to withdraw the fanfold stock material from the dunnage machine supply station and convert the fanfold stock material into low-density dunnage.

39. The dunnage machine supply station of claim 23, wherein the arched surface has an arcuate curve that extends transversely along a majority of the width of the fanfold stock material.

40. A dunnage machine supply station, comprising:
a support including a surface that manipulates a shape of a fanfold stock material into a non-planar configuration; and
a plurality of walls extending adjacent to the support that contain the stack of the fanfold stock material such that the fanfold stock material is able to be withdrawn from a first end of the stack by a dunnage conversion machine that converts the fanfold stock material into low-density dunnage;
wherein the surface has a height between 5% and 20% of a width of the fanfold stock material, and
wherein the non-planar configuration causes fanfolds in the fanfold stock material to resist unfolding upon pulling the fanfold stock material from the first end of the stack in a direction across the fanfolds and non-perpendicularly to the first end of the stack, thereby resisting runout from air currents blowing on an unfolded portion of the fanfold stock material that has been pulled off of the stack.

41. The dunnage machine supply station of claim 40, wherein the surface is an arched surface.
